(19) United States
(12) Patent Application Publication
(10) Pub. No.: US 2006/0095315 A1
(43) Pub. Date: May 4, 2006

(54) Method and apparatus for a mechanized attendance management system

(75) Inventors: Mark Anthony Ano, San Antonio, TX (US); Gary Lawrence Oliver, San Antonio, TX (US); Larry J. Guillory, San Antonio, TX (US); James Alan LaFredo, San Antonio, TX (US); Ronald James Lewis, San Antonio, TX (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 10/977,661

(22) Filed: Oct. 29, 2004

(51) Int. Cl. G06F 11/34

(52) U.S. Cl. 705/11

(57) ABSTRACT

A plurality of data objects are created relating to employee attendance, each data object having a potential relation with one of more other data objects. A trend among individual employees or groups of employees using among a plurality of data objects is evaluated. A course of action is recommended so as to affect the trend. A simple or multi-layered course of action can be recommended as to affect attendance trends. A supervisor is advised of the disciplinary action according to a company policy. Adherence to or deviation from the policy is tracked. The results of policy enforcement are evaluated to determine an effectiveness of the policy.

### BACKGROUND OF THE INVENTION

1. Field of the Invention

The present invention relates generally to an employee attendance management system and more particularly to a system and method that tracks attendance trends and evaluates the effectiveness of related policies.

2. Description of the Related Art

Employee attendance is a constant concern at any business organization. As a company grows, the effect of absent employees takes on greater significance. These effects can be monetarily measured, but other effects are evident, such as, for example, decreased morale.

Several methods for improving attendance are known. Known systems typically provide initiatives on the individual employee level. Also, historical attendance data is typically provided.

U.S. Pat. No. 6,269,355, to Grimse et al., discusses a system and method for guiding a user through a complex process in which the system may automate some predetermined portion of the process and make appropriate support tools available to permit an understanding of underlying rules, requirements, standards, or policies which are necessary to the process steps. These processes may include human resources type of processes, such as discipline processes, compensation processes, attendance management process, work absence processes, employee performance coaching, and the interview process for potential new employees. The invention of Grimse does not operate in real-time or enable a flexibility on the part of the operator.

There is a need for a system and method of managing employee attendance policies in real-time and to evaluate the effectiveness of attendance policies.

### SUMMARY OF THE INVENTION

The present invention comprises a method and apparatus for analyzing attendance and enforcing and evaluating underlying attendance policies. A plurality of data objects are created, each data object having a relation with one or more other data objects. A trend among a plurality of data objects is determined and evaluated. A course of action is recommended so as to affect the trend. The effectiveness of the recommended action in affecting the trend is evaluated.

An example of a data object is an attendance record of an employee. Employees are grouped within various categories within a business. A few examples of such categories include the employee's workgroup, the building in which the employee works, the division of the company in which the employee works, the business sector to which the employee contributes, and the region of the country in which the employee works, among others. Furthermore, an employee can be put in a subcategory of a given category, i.e., the employee works for the human resources division of the company in the Northwest region of the United States. Comparisons can be made between categories as well as between subcategories.

The method and apparatus of the invention evaluates trends among employee categories as well as among individual employees. For an individual employee, a trend can be, for instance, the number of days absent for the employee, a non-random allotment of sick days, a similarity of excuses for absences, etc. Among employee categories, for example, a high number of sicknesses at a given building can be discovered, or seasonal fluctuations in absenteeism can be spotted and corrected or a disciplinary amending action taken.

A course of action can be taken so as to affect the attendance trends. For instance, an employee's absences can be compared to a company's disciplinary attendance policy (DAP) for corrective action. The corrective action can be multi-layered, with the type of action differing depending on the number of absences, i.e., written warning, meet with supervisor, termination, etc. A supervisor is advised of the corrective action required according to the company's disciplinary attendance policy. The supervisor's response in adherence to the disciplinary attendance policy is tracked. Alternatively, the present invention enables the supervisor to choose a separate course of action, that is, the supervisor can override the recommended action. The results of policy enforcement or supervisor action can thereby be tracked and effectiveness of the attendance policy can be reviewed.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For detailed understanding of the present invention, references should be made to the following detailed description of an exemplary embodiment, taken in conjunction with the accompanying drawings, in which like elements have been given like numerals.

FIG. 1 is a block diagram illustrating an example of a process guidance system in accordance with the invention implemented as a client/server system;

FIG. 2 shows a hardware implementation that is suitable for use with the present invention;

FIG. 3 shows a view of a 3-tier logical architecture suitable for use with the present invention;

FIG. 4 shows a flowchart of the present invention for evaluating a disciplinary attendance policy;

FIG. 5 shows a flowchart for enforcing a disciplinary procedure of the present invention;

FIG. 6 shows a flowchart of a typical path the supervisor takes upon initiation of a disciplinary action in the present example of the invention;

FIG. 7 shows an Absence Summary of a workgroup within a company in the present example of the invention;

FIG. 8 shows a workgroup subordinate to a workgroup of FIG. 7 in the present example of the invention;

FIG. 9 shows an Absence Detail page for an individual employee in the present example of the invention;

FIG. 10 shows an Occurrence Management Summary (OMS) page in the present example of the invention;

FIG. 11 shows a Discussion Form page in the present example of the invention;

FIGS. 12a-b show a report displaying information relevant to a disciplinary action in the present example of the invention;

FIG. 13 shows a Discussion Form with relevant checkboxes for summarizing a meeting in the present example of the invention;

FIG. 14 shows an Occurrence Management Detail page in the present example of the invention;

FIG. 15 shows a query page for selecting report types in the present example of the invention;

FIG. 16 shows an Executive Absence Report in the present example of the invention;

FIG. 17a shows a form enabling the generation of a Group Attendance Patterns report in the present example of the invention; and

FIG. 17b shows a report resulting from the criteria selected in FIG. 17a in the present example of the invention.

### DETAILED DESCRIPTION OF AN EMBODIMENT OF INVENTION

In view of the above, the present invention through one or more of its various aspects and/or embodiments is presented to provide one or more advantages, such as those noted below. The present invention is a role-based, policy-driven web tool for monitoring and managing employee absences effectively. It enables managers to view attendance reports and to enforce attendance policies of a company or organization. It manages multiple attendance policies at the same time. Users can access the system through an intranet, the internet or any other data network.

Users of the present invention include supervisors and managers. Supervisors can view their team's historical absence records on an individual and on a team basis. Supervisors are also alerted when disciplinary action needs to be taken due to an employee's absence, are informed of the exact discipline to use, and are given an opportunity to enter comments after such action is taken.

Features facilitating the role of the supervisor include: viewing attendance results and absence occurrences in hours, days or percentages, identifying employees whose absence rates exceed the applicable regional attendance standard, receiving automated emails regarding multiple occurrences (as defined by policies) of unexcused absences by a particular employee, viewing comparisons of trends and objectives, viewing reports with drill up and down capabilities, assistance in making behavioral modifications, determining disciplinary actions required, documentation of discipline discussions for back-up in grievances and arbitration, escalating to a next level of management if appropriate action is incomplete, and printing award certificates for employees with good attendance.

Attendance managers handle high-level attendance issues. Features facilitating the role of the attendance managers include: identifying regions/work groups/organizations with high and low incidence levels; viewing monthly and seasonal employee absence trends (historic views); assisting in making behavioral modifications, creating attendance targets for work groups, locations, and divisions; comparing group and individual attendance results against team objectives; and supplying audit reports and track adherence to policies, and escalation reports as needed.

Additional functionality of the present invention is extensive. Among others, the present invention provides a comprehensive picture of absences by companies, business units, workgroups, employees, and locations. Absence data can be integrated from multiple sources. The present invention supports business rules related to attendance management and actions required for multiple attendance policies. It tracks lost-time/absenteeism metrics at individual and group levels for illnesses (excused and unexcused), disability, FMLA (Family and Medical Leave Act), Work Accommodation/Restrictions, Leave Of Absence, Worker's Compensation, and Unexcused non-illness Absences. Dynamic reports can be created with personalized views and predefined reports, such as Employee Attendance History, Excused Absence, Executive Absence (bird's eye view), and Group Attendance Patterns. Examination of absence reports enables a manager to spot absence trends and to determine an effectiveness of company policy or enforcement of the company policy in reducing absenteeism.

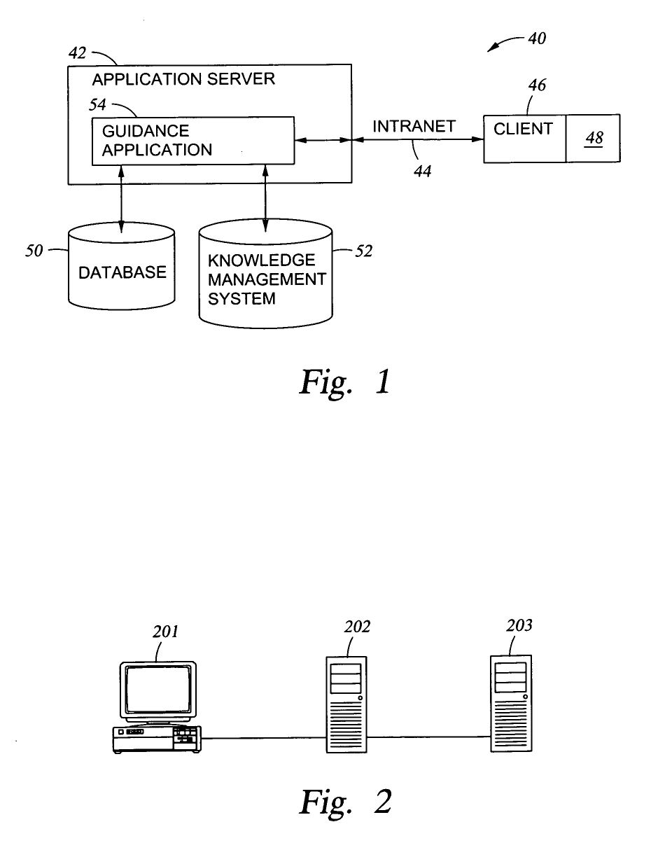

FIG. 1 is a block diagram illustrating an example of a process guidance system 40 in accordance with the invention implemented as a client/server system. It should be understood, however, that the process guidance system in accordance with the invention may be implemented in a variety of different computer systems and the invention is not limited to the client/server architecture shown. For example, the system 40 may utilize multiple client servers and/or the internet. In this example, the system 40 may include a server computer 42 connected via a computer network 44, such as a corporate Intranet, to one or more client computers 46 (although only one client computer is shown in this example) and one or more database servers 50, 52. The system may service an enterprise, such as a business organization. The database contains employee absence records, employee demographics and disciplinary attendance policies. A processor in the client computer may execute browser software 48 and access a common object request broker in order to access information from the database servers, interact with the application server and exchange objects with the server. The server 42 may be connected to one or more database servers (dB) 50, which store various data associated with the enterprise such as employee records, demographics and data, and may also be connected to a Knowledge Management System (KMS) 52 which stores the process guidance system and method in accordance with the invention. The KMS also permits the guidance pages, as described below, to be automatically generated from one or more page fragments having preconditions.

The KMS 52 may be controlled by a software application 54 being executed by the processor in the application server 42 which interacts with the client computer 46. For example, the software application 54 may generate the user interface windows shown on the browser application 48 and receive input from the user. The software application 54 may also access the process guidance stored in the KMS 52. Each software application 54 may guide a user through a different process. The process guidance contained in the KMS 52 may be manually generated after reviewing the process to be modeled.

In particular, the process guidance system of FIG. 1 may include a logical structure, such as a decision tree or a decision matrix as described below, which permits a process to be broken down into a sequence of one or more logically related process steps. The steps may include requesting information from the user of the system, providing guidance pages to the user of the system or recommending an action based on the information supplied by the user of the system and the particular company policy. Each step may be represented as a node of the logical structure. At each step of the process, the node of the logical structure representing that step of the process may include a guidance page, as described below, which permits the user of the process guidance system to receive information about the particular step in the process. For example, the guidance page may provide answers to frequently asked questions, may further define a particular term needed to make the decision, may provide the user with the choices at that particular point in the process or may make recommendations about actions to be taken by the user of the system. The guidance pages may also, where appropriate, recommend or require that the rest of the process be handled by a process expert, such as a human resources manager.

The KMS 52 may be used to implement guidance for a variety of different processes which are well known to an expert, but for which other employees may require some guidance to navigate through the process. These processes may include human resources type of processes, such as discipline processes, compensation processes, attendance management processes, work absence processes, employee performance coaching, and the interview process for potential new employees. The processes may also include any other process which an employee may be guided through, such as the re-tooling of a manufacturing plant, the safety review of a manufacturing plant and the like.

To guide a user through the process, a logical structure is generated which represents the entire process since each node of the logical structure may represent a single step of the process. The logical structure may be generated based on the steps of the process and the policy behind the process since the policy may determine, for example, the actions to be taken by the user in response to a problem. The logical structure codifies the policy into discrete steps through which a user may be guided. To add information unique to a particular company or situation or customize the guidance system, the guidance system may include the guidance pages.

In operation, the user of the process guidance system (e.g., a manager or supervisor) may have, for example, a discipline problem with an employee which the manager does not know how to handle. As opposed to relying upon the human resources department, the user may log into the process guidance system in accordance with the invention and, in particular, a discipline module within the process guidance system since the process guidance system may guide a user through multiple different processes. Once logged into the process guidance system, the user may be prompted, for example, to enter various information about the problem employee in a series of steps into the system. This information may be transferred back to the server and stored in the database in the employee's record so that the human resources department may later review the record as needed. In addition to gathering information from the user about the employee, the system may begin to guide the user through the discipline process. Thus, the user of the process guidance system does not need to understand the process nor the policy underlying the process since the logical structure ensures that the policy is being followed. As long as the user enters the requested information, the process guidance system makes the decisions based on the information according to the policy.

A company may have different policies for different conduct problems so that the questions help the process guidance system determine the policy which applies to the particular problem. Once the type of conduct is identified, the process guidance system may ask additional questions to determine the appropriate level of discipline for the particular offense. For example, a first time offender may receive a lighter discipline (a private talk with the manager) than a repeat offender (an official letter to the file or even dismissal). The process guidance system, based on the gathered information about the employee and the policy of the company, eventually may recommend a disciplinary action for the employee (talk with manager, formal reprimand, termination, etc.) and provide the user with instructions for carrying out the discipline. For example, the process guidance system, through the guidance pages, may provide the user with a script for an informal talk with the employee about the problem. For more severe discipline, the process guidance system may direct the user to call human resources and have human resources handle the discipline. In this manner, the complex process of disciplining an employee may be somewhat automated so that even a manager with no knowledge of the company policy nor the discipline process may be able to accomplish a majority of the discipline process.

FIG. 2 shows a hardware implementation that suitable for use with the present invention. A client layer 201 interfaces with a user (employee, supervisor, manager, etc.). A database server 202 stores pertinent data (employee absences, company policy, disability data). An application server 203 retrieves data from the database server and produces reports and summaries for the client.

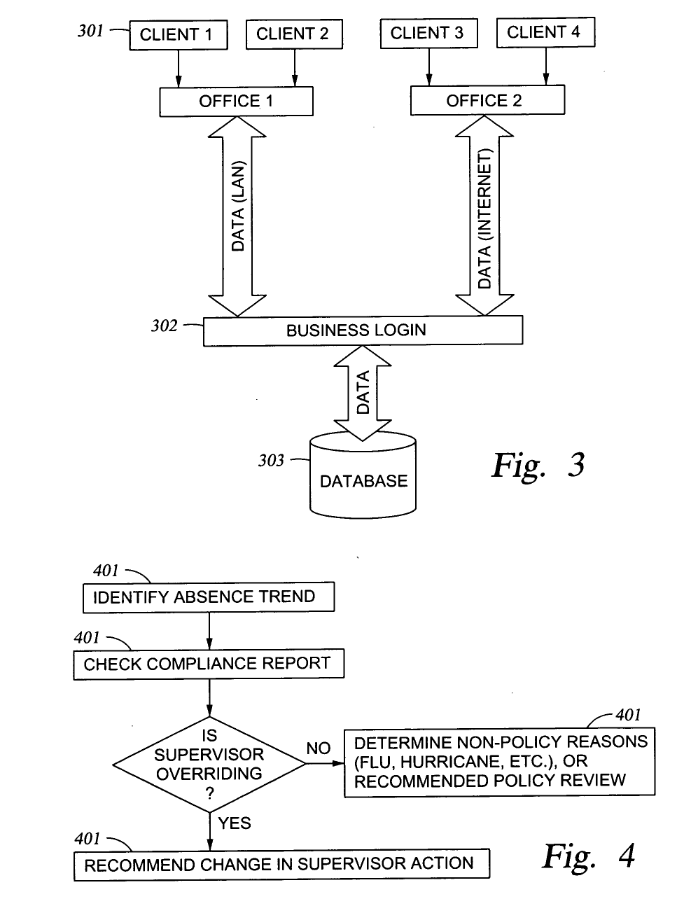

In an exemplary embodiment, a three-tier architecture system can be used to implement the present invention. FIG. 3 shows a view of a 3-tier logical architecture suitable for use with the present invention. A presentation layer 301 is employed as a user interface. At the presentation level, the user inputs data into the system and output is displayed back to the user. Applications at the presentation layer can be written using, for example, HTML, JSP, XSL, or Javascript. Business logic is implemented at a business layer 302. Data is validated at this level before being added to the database or presented to the user. An implementation of this level can be achieved using object-oriented technologies. Communication between the presentation layer and the business layer can be over LAN or over an internet or other data network connection. A data layer 303 provides connectivity of the business layer to a database. The data layer contains database tables, stored procedures, functions, and views, and the ability to pack and unpack data. Oracle can be used in a typical implementation of the data layer, thereby enabling operation of the present invention across a variety of operating systems (Sun, UNIX, Windows, etc.). A flexible architecture enabling integration with other systems is characteristic of the present invention. Implementation can be also made across a variety of layered systems.

Multiple attendance policies can be managed concurrently. Additions or modifications to policies are typically performed by a programmer, but can also be entered through a web-based administrative system. The structure of the present invention is such that changes and additions affect a minimum number of files (in many cases changing one policy affects only one file). Integration with other backend systems is easily facilitated.

The ability to operate using current data enables real-time management. Employee information can be loaded daily using a variety of methods, i.e. punch cards, bar code, employee badge identification, computer terminal entry. Some or all such information may be entered in real time. An exemplary procedure of data entry is through eLINK, an SAP solution which enables employees to access or enter payroll and time information online. Hourly employees typically have time automatically entered into eLINK through other systems. Information may be automatically entered when an employee uses an identification badge (security card). Data may also be entered from any remote location via the internet, phone lines or other wireless systems. Employees or others may also enter “exception time information,” such as, scheduled vacations, leaves of absence, etc. Also, Medical Absence and Accommodation Resource Team information, and Family Medical Leave Act (FMLA) also can be entered daily. Administrative and policy data are typically entered over a longer time scale. For example, data related to Worker's Compensation plans for some regions and business units can be entered monthly. A plurality of data sources is used, i.e. eLINK, SBC Medical Absence and Accommodation Resource (SMAART), Helmsman Management Services data systems, FMLA, etc.

FIG. 4 shows a flowchart of the present invention. In Box 401, an absence trend is identified. Generally, such trends are abnormally high absentee rates within a geographical location, building location, workgroup, etc. A compliance report is generated (Box 402). A compliance report can be, for example, the track record of a supervisor in enforcing the disciplinary procedure within a group having a high absentee rate. The ability of the supervisor to apply the procedure is noted. If it is determined that the supervisor has overridden the procedure, then a change in the supervisor's method can be recommended (Box 409). Otherwise, if the supervisor is following the procedural guidelines, one can look for other causes of high absenteeism (flu, hurricane, etc.) or recommend a change in policy to better obtain the company's goals (Box 407).

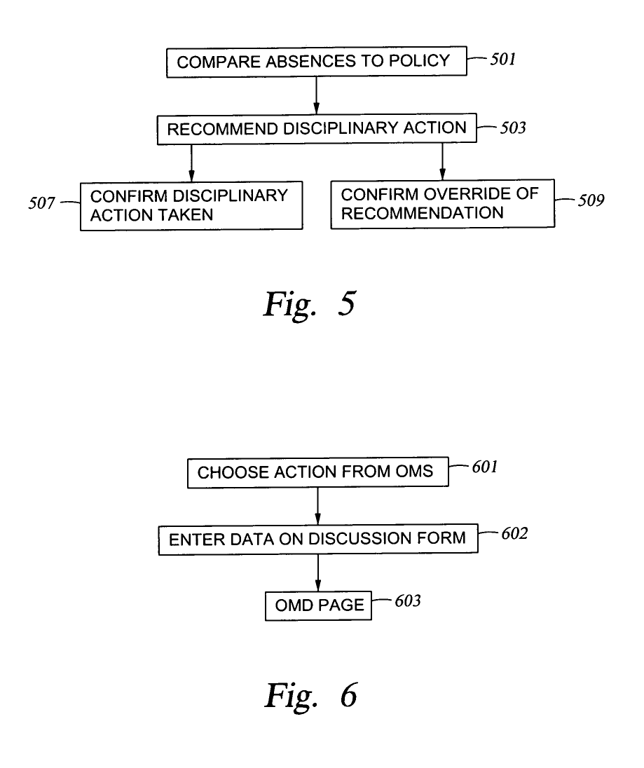

FIG. 5 shows a flowchart of a disciplinary procedure of the present invention. In Box 501, data concerning an employee is compared to guidelines presented in a company's policy. When an incidence occurs which requires a disciplinary action, the present invention will notify a supervisor of the employee and the level of disciplinary action need (Box 503). A series of pages guides the supervisor through the disciplinary action, with the results being stored in the system (Box 507). In some instances, the supervisor will be able to override the recommendation of the system. Overrides are stored for evaluation of the disciplinary attendance policy. When this occurs, the results can be also recorded back in the system (Box 509).

FIG. 6 shows a flowchart of a typical path the supervisor takes upon initiation of a disciplinary action. A supervisor uses the OMS as a first page for generating a disciplinary action (Box 601). A Discussion Form is presented which facilitated the necessary action for the supervisor to take at that time (Box 602). Upon completion of the action, the supervisor is presented with the OMD page (Box 603), which displays the results of the action as well as its current status.

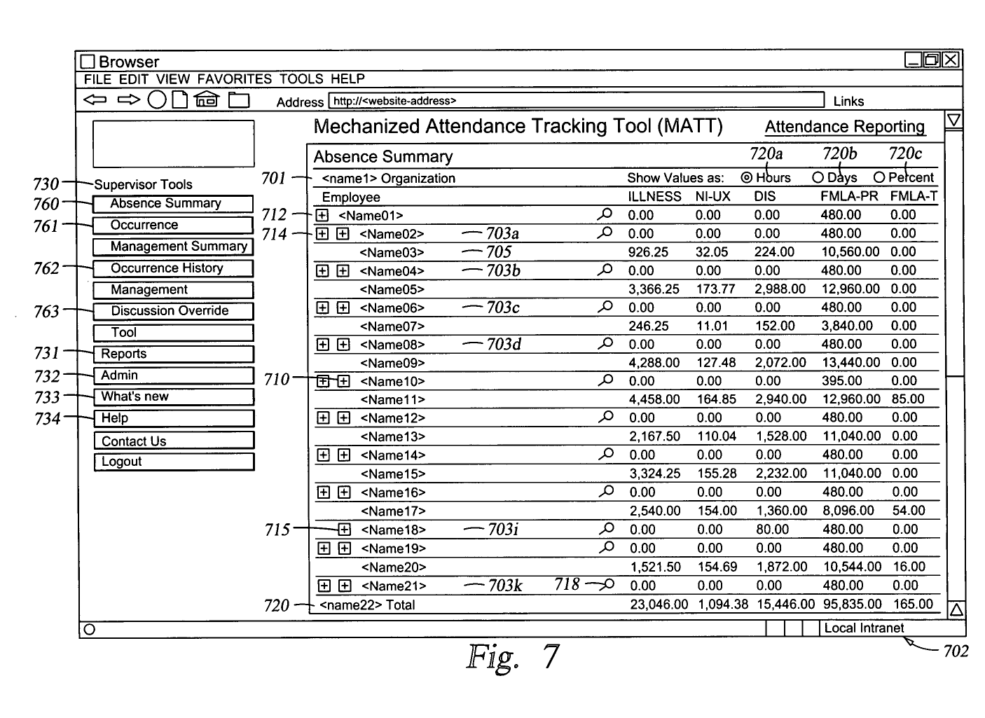

Flow through the present invention is facilitated by use of a navigation bar, such as seen for example in FIG. 7. First level option for the user enable Supervisory Tools 730, Reports 731, Administrative Tools 732, a “What's New” page 733, Online Training and Help 734. Selecting the Supervisory Tools enable enforcement of company attendance policy. Examples of Supervisory Tools include an Absence Summary 760, and Occurrence Management Summary (OMS) 761, an Occurrence History Management (OHM) 762, Discussion Override Tools (DOT) 763, and Count on Me Certificate.

FIG. 7 shows an Absence Summary of a workgroup within a company. The Absence Summary page enables a supervisor to view attendance results for the previous 12 months, as well as view individual employee details. This screen includes absences recorded in the last 12 months, whether or not such absences are chargeable. Navigation from the Absence Summary page to other pages is via several hyperlinked icons. Clicking one designated icon (i.e. “up” arrow, 712) enables the user to drill up to a higher-level workgroup, such as their immediate supervisor's workgroup. Through repetition, one can continue drilling up the chain of command. Also, another icon (i.e. “down” arrow, 714) enables supervisors to drill down to direct reports of their subordinate's absence details. Clicking on yet another icon (i.e., “+” sign, 710) expands an employee's workgroup within the current summary page. Clicking on another icon (i.e., magnifying glass image, 718) directs user to an “Absence Detail” page which displays an employee's individual absence details.

Table 702 displays categorized information in several columns, i.e. employee name (Employee), Absence due to illness (ILLNESS), Unexcused Non-Illness Absences (NI-UX), Disability (DIS), Family and Medical Leave Act (FMLA). The name of the workgroup leader 701 is displayed above the table. The workgroup leader also serves as the first entry in the table. The total number of absences within the workgroup is displayed in the last row 720 of the table. Sharon Bray heads the workgroup shown in the example of FIG. 7. A list of immediately subordinate personnel (703a, . . . , 703k) is also shown. The subordinate position of an employee is indicated, for example, by indentation of employee name. The attendance record of each of the subordinate managers and a group attendance record of that manager's lower-level workgroup is also displayed. For example, the individual attendance record of Pauline Baskiel (703a) is displayed as well as the group attendance record of her workgroup (705). An icon (715) indicates those personnel who do not head a lower-level workgroup (i.e., employee 1 703i and employee 2 703k). Attendance results and absence occurrences can be viewed in hours, days or percentages by selection of radio buttons 710a, 710b, and 710c, respectively.

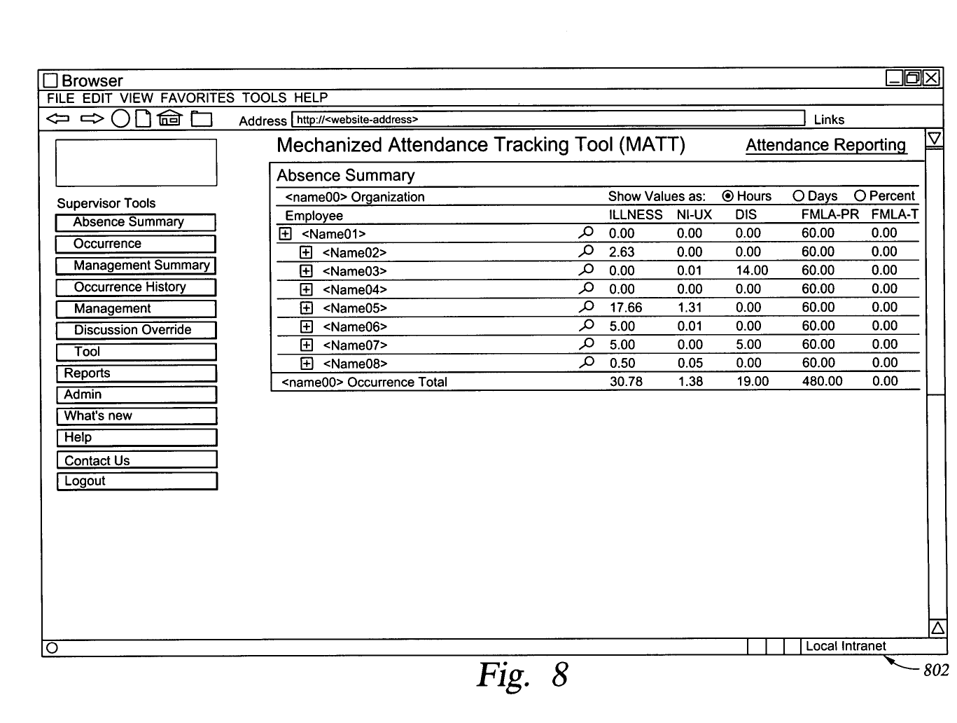

FIG. 8 shows a workgroup subordinate to the supervisor 1's workgroup of FIG. 7. The workgroup of FIG. 8 is headed by supervisor 2. The name of supervisor 2, which is displayed at position within table 703c of FIG. 7, is now shown above the table 802 of FIG. 8. Similar to table 702, employees subordinate to Lynda Garman are displayed in a subordinate position in table 802.

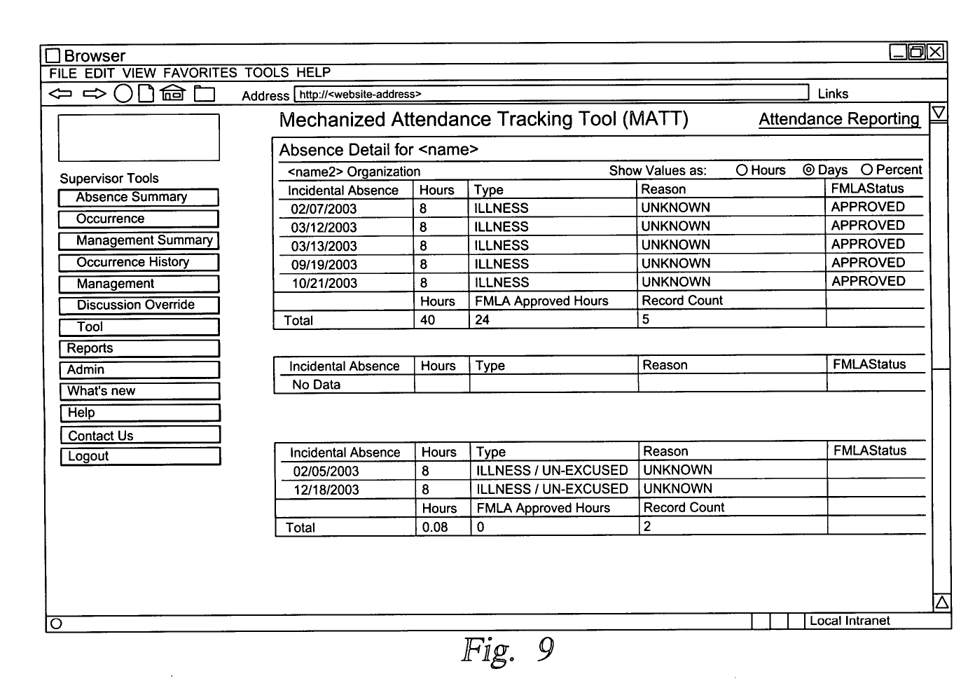

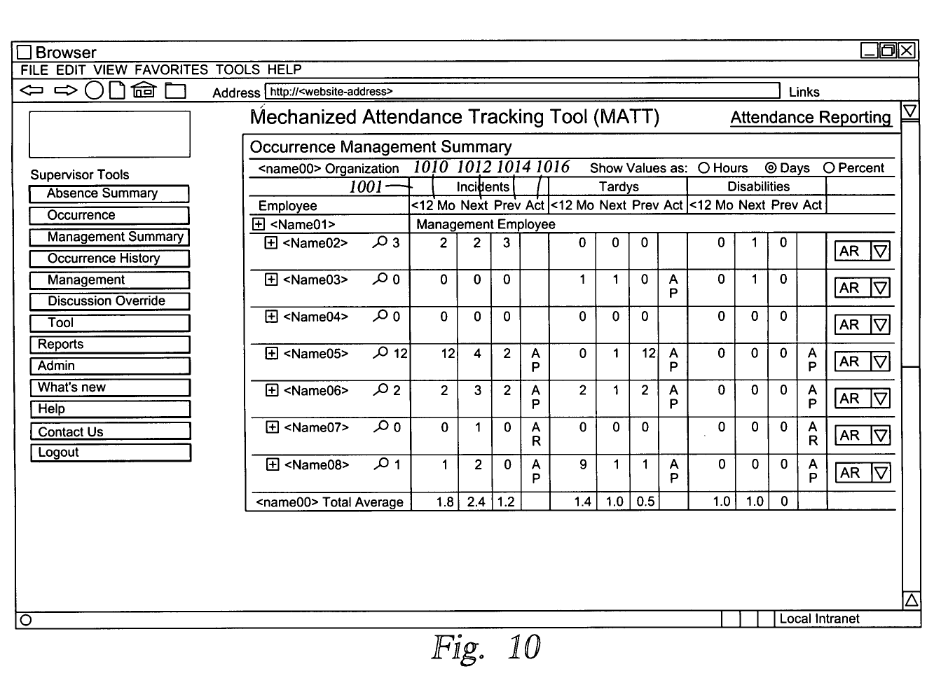

FIG. 9 shows an Absence Detail page for an individual employee. Absences are categorized, i.e. Incidental absence, Disability, Tardies and relevant information shown (i.e., date, lost time, type of absence, reason for absence, and FMLA status, etc.). The user has the option of viewing absences in hours or days.

FIG. 10 shows an Occurrence Management Summary (OMS) page. An OMS page enables the supervisor to view their immediate group's attendance history within the last 12 months by category. User can click on the “Magnifying Glass” image and be directed to an “Occurrence Management Details” page. A first grouping of columns represent absences according to category (i.e., Incidentals, Tardies, and Disabilities). Each category of absences are divided into a second level of columns. Within each category, an employee's current attendance standing as well as disciplinary actions is tracked. For example, the column titled Incidentals 1001 comprises 4 sub-columns: “<12 Mo” (1010), “Next” (1012), “Prev” (1014), and “Action” (1016). Column 1010 displays the number of absences within the past 12 months.

Typically, an organization will have a policy of recommended disciplinary actions to take based on the attendance record of an employee. The disciplinary procedure also generally depends on the number of years of service of an employee, so the present invention manages a plurality of disciplinary policies. For example, a company policy might state that after 2 unexcused absences, the employee must complete an Attendance Review, after 4 unexcused absences, the employee attends Counseling, after 5 unexcused absences, the employee is handed a written warning of dismissal and after 6 unexcused absences, the employee is dismissed.

Column 1012 shows the next level of discussion or discipline that will be recommended for the employee pending the current level. Column 1014 displays the previous level of discussion or discipline that has been taken with the employee. The standing of a disciplinary action is tracked in column 1016. For instance, “Action Required” alerts the supervisor when a discussion should be initiated with the employee. “Action Pending” alerts the supervisor to complete the record of discussion. In the example of employee 3, she has had 2 absences within the past 12 months, the previous level at which disciplinary action must be taken is also 2 absences. An “Action Required” field is therefore displayed. The next level of disciplinary action occurs for employee 3 at 3 absences. The field indicating the disciplinary process can be coded, for example, using colors.

The OMS advises a supervisor of a necessary disciplinary action to be taken and tracks the disciplinary process of that supervisor. If discussion is pending for any employee then “Action Required” will be displayed in an “Action” column. “Action Pending” is displayed to alert the supervisor to complete and submit results of a disciplinary action. Once a supervisor clicks on either “Action Required” or “Action Pending” link he/she will be directed to a “Discussion Form” page. The required action can be coded for easier understanding by the user (i.e. color-coded highlighting).

In an exemplary representation in FIG. 10, a red-highlighted field indicates that an action is required and a yellow-high-lighted field indicates that an action is pending. Actions chosen from the dropdown box under the column titled General are for use in initial attendance review (IAR), attendance review (AR), Pregnancy Disability Leave (PDL), and FMLA discussions. Choosing an action (any action under General, “Action Required”, “Action Pending”) presents a supervisor with a Discussion Form. The supervisor enters any comments in a provided textbox and checks any appropriate check boxes. Upon clicking on an appropriate tab on the Discussion Form, an OMD page is displayed, displaying the action taken by the supervisor. The field can be highlighted according to the status of the action taken.

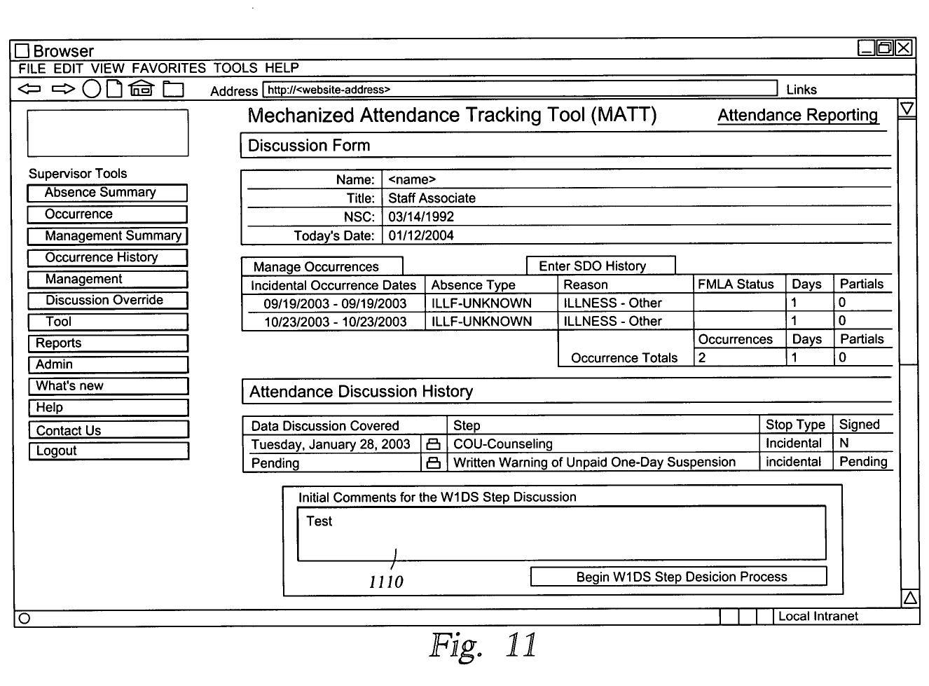

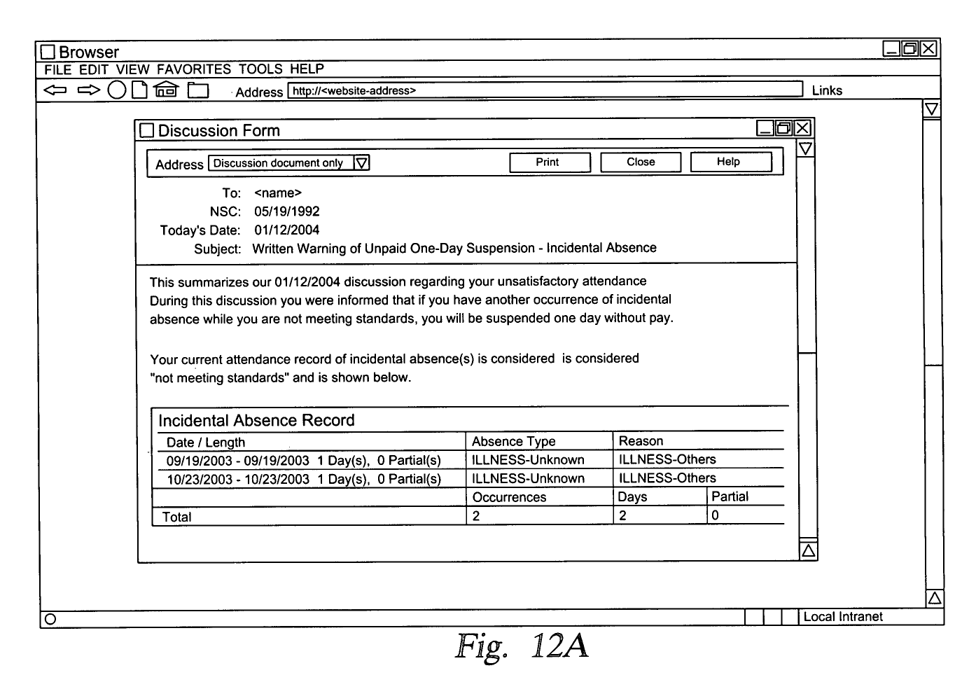

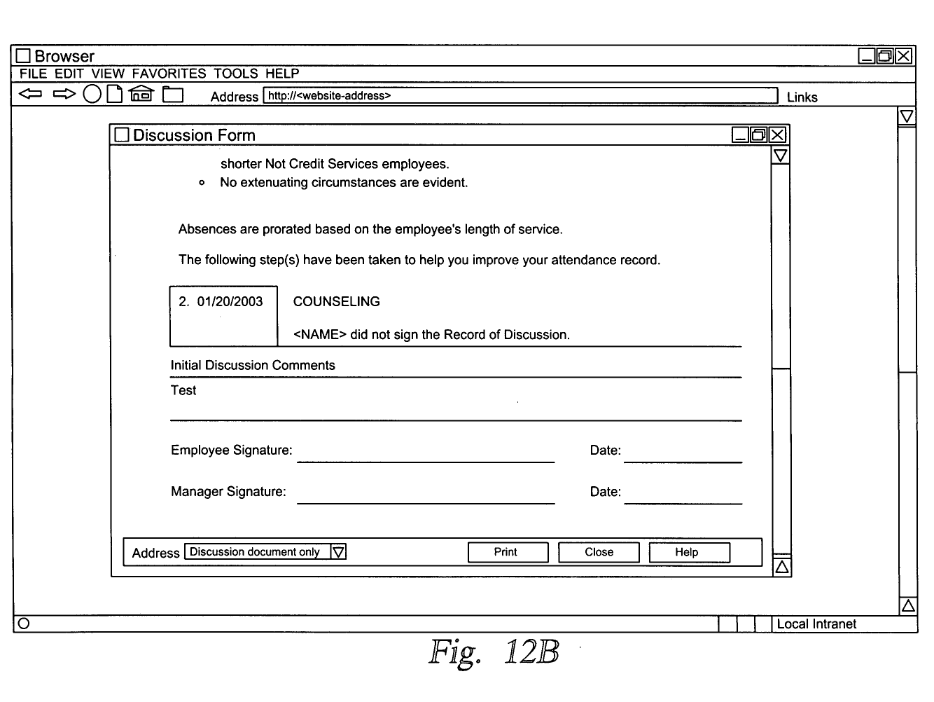

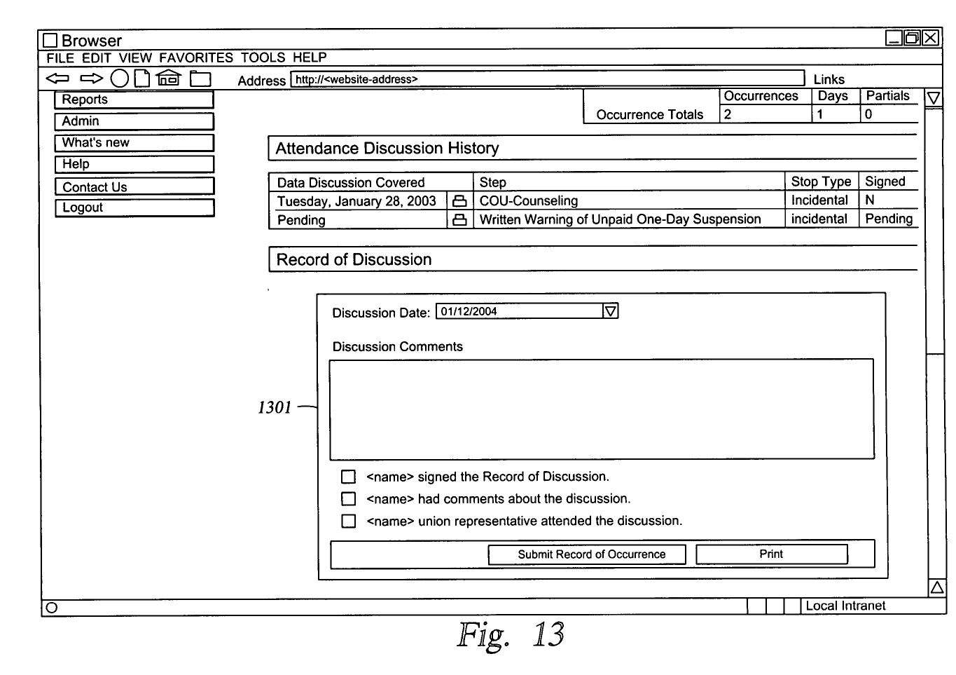

The layout of the Discussion Form depends on the reasons for accessing the page. When supervisor initiates a discussion for General discussion (IAR, AR, PDL, FMLA) or because an “Action Required” field is displayed, the resulting Discussion Form (FIG. 11) enables a supervisor to enter pre-meeting comments in a provided textbox 1110. Upon submission of comments, a report (FIGS. 12a, 12b) is displayed addressing relevant material (i.e., why the employee is being counseled, number of absences). When supervisor initiates a discussion because an “Action Pending” field is displayed, the Discussion Form (FIG. 13) displayed relevant checkboxes 1301 summarizing the meeting accompany the provided textbox.

A supervisor or attendance manager can override a recommended course of action. Sometimes the next step of discipline on an absence is not appropriate based on the reason of the absence. For example, one set of criteria for breaking with policy might be as follows: 1. employee is on a step of discipline that is pay effecting or termination; 2. employee has at least 45 consecutive days of satisfactory attendance before override; 3. supervisor can only override discipline steps one time during one unsatisfactory period; 4. absence still counts as an occurrence so a discussion must take place; 5. approval is along chain of command, etc. A button enabling supervisor to perform the Override is displayed once this criteria is met.

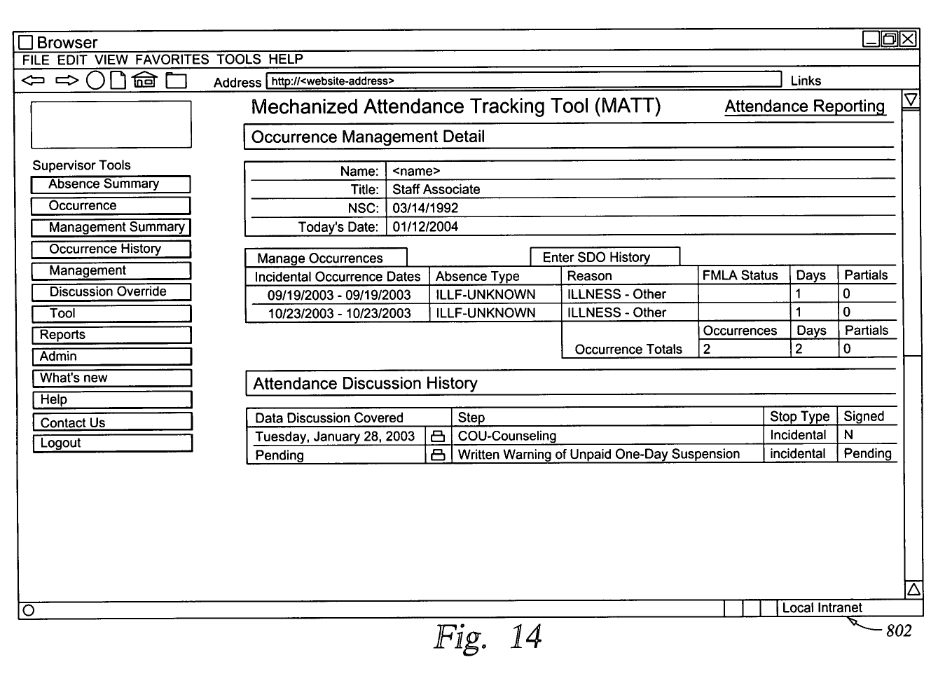

FIG. 14 shows an Occurrence Management Detail page. An OMD page enables users to view the details of the employee. Several tabs offer further capabilities. For instance, a “Manage Occurrences” tab directs the user to a page, which enables combination of occurrences which should be combined on the attendance record to reflect as one or the separated into multiple occurrences. An “Enter SDO History” tab directs the user to a “Scheduled Day Off (SDO)” page in which a user can enter multiple scheduled days off that impact non-salaried employees. An “Add Absence Data” tab enables the user to address absences within a local 24-hour timeframe in place in various organizations. A “Remove Added Absences” tab directs the user to the “Remove Added Absences” page. Detailed information relating to the employee's absences are displayed on the OMD. Detailed information on discussions with the employee (Occurrences Total Attendance Discussion History Date Discussion Covered) are also displayed in a separate section (Attendance Discussion History).

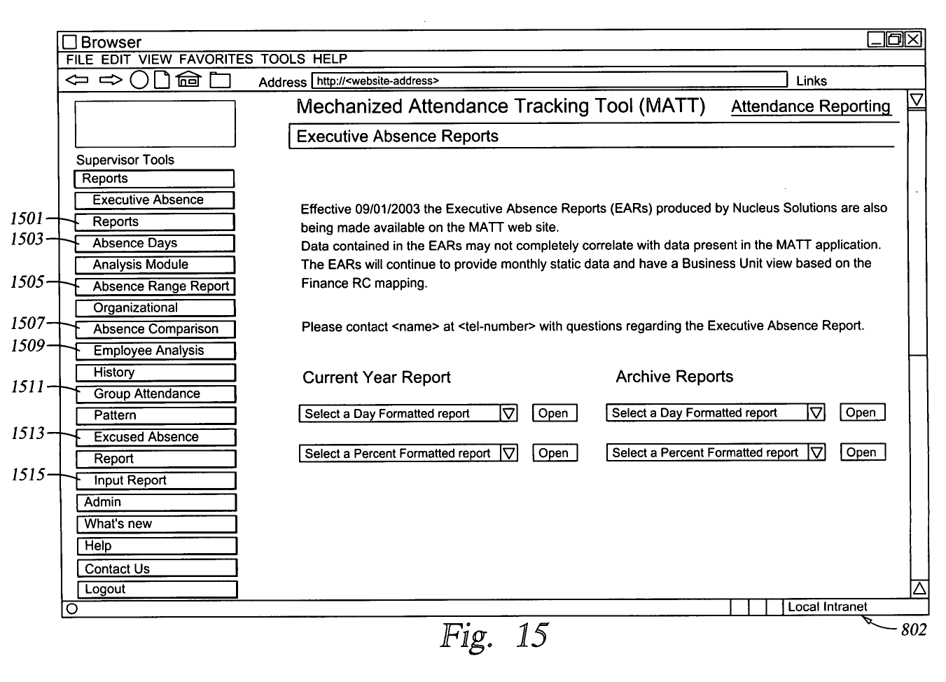

Options for selecting reports are discussed here. Reports enables a user to track absence trends as well as compliance with company attendance policy. Reports can be made for individual employees or for a grouping of employee along working relationships (i.e., same workgroup, same region of country, same place of work). FIG. 15 shows a query page for selecting report types. Selecting Reports on the navigator tab displays types of reports. Some examples are the Executive Absence Reports (1501), Absence Data Analysis Module (1503), Organizational Absence Comparison (1505), Absence Range Report (1507), Employee Attendance History (1509), Group Attendance Patterns (1511), Excused Absence Report (1513), and Input Report (1515).

A “Count On Me” report tracks good attendance for supervisor managers and serves as an attendance award tracking and recognition program. Relevant exceptions for attendance can be noted, such as absences due to jury duty, voting, funeral time, union time, religious observances, Pioneer Officer time, e-time (eLink companies), or military duty/military leave of absence, among others, so that the employee will remain eligible to be awarded a Count on Me certificate. A supervising managers receives an e-mail notifications whenever one of their direct-report non-management employees reaches Count On Me eligibility. Upon receipt of the e-mail notification, managers can log in and create the Count on Me certificate. A “Count on Me Certificate” is found under Supervisor Tools.

An “Employee Attendance History” report provides employee absence rates and can be used to compare an organization's absence rates and a specific employee level. The Employee Attendance History Report can be available using both a static hierarchy and a dynamic hierarchy.

A static hierarchy provides “snapshot” view of an organization at a point in time. As an example, Jane Doe's absence results attribute to and remain in the organization for which she incurred the absence(s). If Jane incurs absences in a first organization and then moves to a second organization, her absence incurred in the first organization remains in the first organization. The organizational hierarchy and absence results are then static and never change. Such a snapshot can be taken, for example, on the first calendar day of each month for the prior month. Under a dynamic hierarchy, historical absence results change daily based on organizational movement and payroll/time changes. This is a “current” view of an organization. An organization's absence results are comprised of today's employee population and their historical absences, regardless of what organization they were in when the absence was incurred. As an example, Jane Doe's absence will be captured in an organization for January through December even though she was in a separate organization from January through June. All of Jane's absence is captured in the organization for which she currently resides. From this perspective, historical absence follows the employee to their current organization.

An “Excused Absence Report” (EAR) provides a detailed trending view of excused absences at the President and Senior Manager level. Data is categorized into specific types of excuses absences by month to show the relative impact. Categories are also divided by Paid and Unpaid time to illustrate the impact of the absences to an organization's business. The EAR page enables users to pull a report for excused absences. A user selects the business unit from a drop down list to pull the report. A user also selects a report view from a drop down list (i.e., All Employees, Non-Management, and Management).

An “Absence Rates by Location” page enables supervisors and business units to pull reports by location and to rank results. Specific absence rates can be used to identify locations having the best or worst absence rates within an organization. Supervisor location rankings can range from president level to first level supervisors. Locations are ranked based on a variety of criteria, such as Annualized Absence Days per Employee (AADpE), Absence Days per Employee (ADpE), or Total Absence Days. Results can be ranked based on a combination of absences, such as Incidental and Disability Absences.

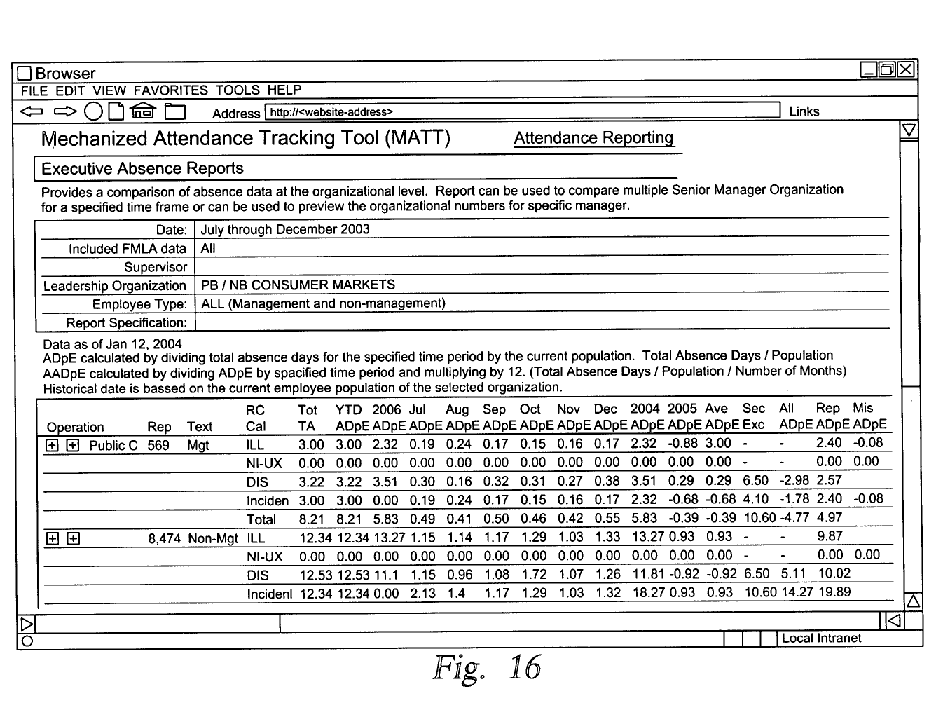

FIG. 16 shows an Executive Absence Report based on selected criteria. An EAR enables comparing organizational absence results by supervising managers. Comparison of absence results can be made among multiple organizations, under one supervisor, or under various supervisors where security permissions are applicable. Some criteria for report querying include: Date Range, Include FMLA Data, Supervisor user ID, Leadership/Organization(s), Employee types, and region specification. A highlighted row or table entry indicates to user areas of concern.

A “Historical Executive Absence Reports” provides monthly static data and business unit review based on finance RC mapping. Historical Executive Absence Reports are divided into two following sections: Current Year Reports, and Archived Reports. In each section a user can pull the report using a Day-Formatted Report or a Percent-Formatted Report.

A “Group Attendance Pattern” report enables a user to pull month-to-month trends for specified senior manager's organization. This report can be useful to review absence trends within the group. A set of fields for querying the database is presented to the user. A standard categorization scheme for use in spotting trends is generally used. However, flexibility of the present invention enables a user to track additional trends (seasonal absences, absences near holidays or weekends, absences due to natural disaster, etc.)

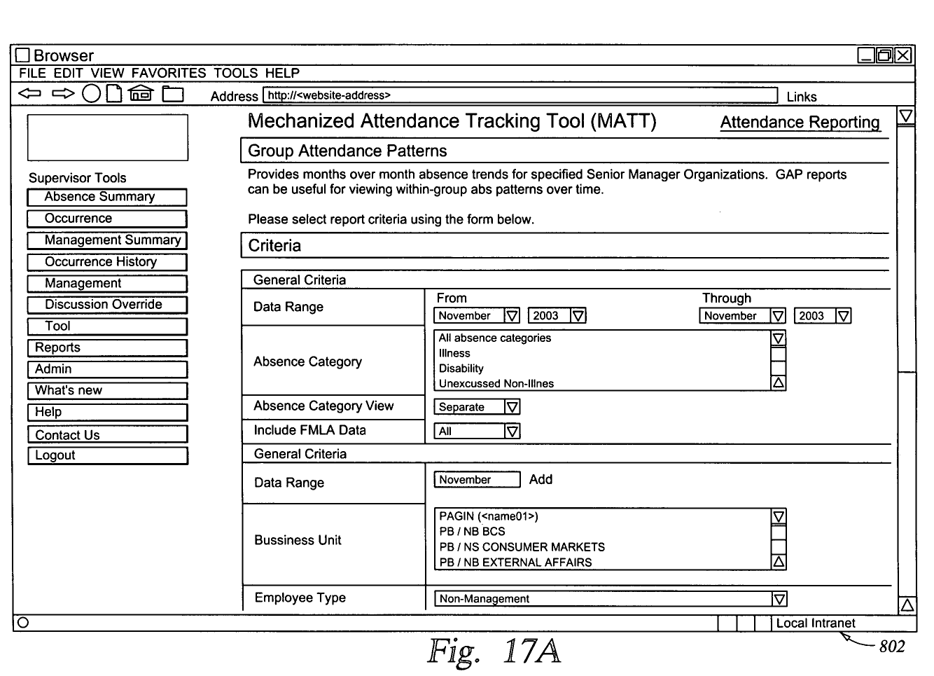

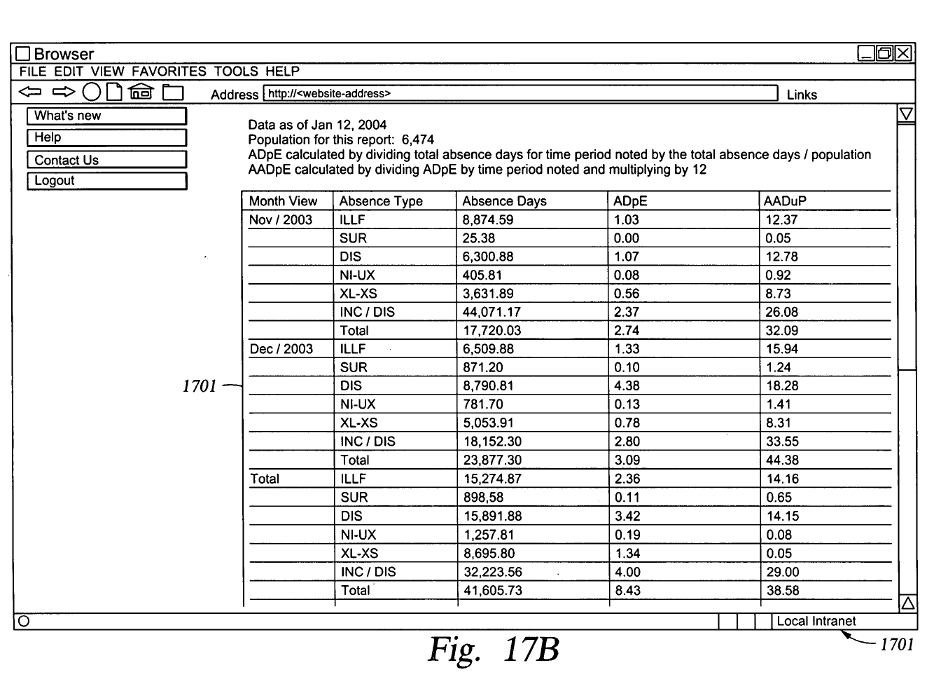

FIG. 17a shows a form enabling the generation of a Group Attendance Patterns report used selected criteria, such a date range, attendance category, absence category view, business unit, etc. A range of dates is to be selected using drop down boxes 1701. An Absence Category 1702, Absence Category View 1703, and an option to include FMLA data 1704 is presented. From the Absence Category, a user can select one or all of the categories from the drop down list. Listed categories are as follows: All Absence Categories, Illness, Disability, Unexcused Non-Illness, Excused/Excluded, and Surplus. In Absence Category View, user selects the view of the report. Displayed view options are Roll Up and Separate. Under “Include FMLA Data” user pulls a report specific to FMLA Data (All, FMLA, Non-FMLA).

FIG. 17b shows a report resulting from the criteria selected in FIG. 17a. Results are shown in table format. A row displaying occurrences that are not in compliance with company policy is highlighted (1701), thereby enabling a user to easily identify problem areas. An audit can be triggered for non-complying groups.

An “Organizational Absence Comparison” report enables comparing absence data at the organizational level. This report can be used to compare multiple senior managers organization's for specified time period.

Administrative tools allow for security procedures and an ability to update the system. A “Security” page enables a system administrator to grant access to other employees based on their role by user ID. A “What's New Administration page enables a user to upload new documents pertaining to the invention. Functionality and management documents are provided. An “Online Training” page displays all the information about getting trained on the system. This page displays links to documents for user guides and manuals. This page also displays links to tutorials for regions and also for reports.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Further, the system of the present invention provides a substantially online, real-time system for managing attendance throughout an organization, wherein attendance-related data may be entered at various locations and through various input devices, some of which data may be entered in real-time and may include exception time reporting. The system further provides selected attendance reports to employees, supervisors and management personal in real time through an intracompany server and/or via the internet.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

1. A computerized method for managing an attendance, comprising:
evaluating an attendance trend among a plurality of data objects having a relationship;
recommending an action affecting the attendance trend; and
evaluating the effectiveness of the action in affecting the attendance trend.

2. The method of claim 1, wherein the attendance trend comprises at least one of a pattern of absences, geographical distribution of absences and work group distribution of absences.

3. The method of claim 2, wherein the pattern of absences comprises at least one of an absence proximate a holiday, absence proximate a weekend, absence proximate a recurring date and absence concurrent with a weather condition.

4. The method of claim 1, wherein the data objects comprise absence records and employee demographics.

5. The method of claim 1, wherein the relationship comprises at least one of an employee, a workgroup, a building, a business unit and a geographical region.

6. The method of claim 1, wherein the recommending an action comprises:
comparing the attendance trend to a disciplinary attendance policy; and
recommending a disciplinary action in accordance with the disciplinary attendance policy.

7. The method of claim 1, wherein the affecting a trend comprises reducing absenteeism.

8. The method of claim 1, wherein the recommending an action includes rewarding attendance that meets an attendance criterion.

9. The method of claim 1, wherein evaluating the effectiveness of the action comprises:
recommending enforcement of a disciplinary attendance policy when the recommended action is not being performed; and
recommended review of the disciplinary attendance policy when the recommend action is being performed.

10. The method of claim 9, wherein the review of the disciplinary attendance policy comprises, systematically eliminating non-contributing factors to determine a cause of the trend and recommending a change in the disciplinary attendance policy.

11. The method of claim 1, further comprising inputting attendance records at least partially in real time.

12. The method of claim 11, wherein inputting attendance records at least partially in real time includes inputting the attendance records via one of (i) an employee identification device; (ii) a computer (iii) a wireless device; and (iv) the internet.

13. The method of claim 1, further comprising:
inputting the plurality of data objects into a database;
providing a plurality of attendance policy criteria; and
evaluating a data objects in the plurality of data objects as a function of the attendance policy criteria for recommending the action affecting the attendance trend.

14. The method of claim 1, further comprising providing a plurality of online accessible reports for a plurality of management levels.

15. A computer readable medium containing computer instructions that when executed by a computer perform a method for managing an attendance trend, comprising:
evaluating an attendance trend among a plurality of data objects having a relationship;
recommending an action affecting the attendance trend; and
evaluating the effectiveness of the action in affecting the attendance trend.

16. The medium of claim 15, wherein in the method, the attendance trend comprises at least one of a pattern of absences, geographical distribution of absences and work group distribution of absences.

17. The medium of claim 15, wherein in the method, the pattern of absences comprises at least one of an absence proximate a holiday, absence proximate a weekend, absence proximate a recurring date and absence concurrent with a weather condition.

18. The medium of claim 15, wherein in the method, the data objects comprise absence records and employee demographics.

19. The medium of claim 15, wherein in the method, the relationship comprises at least one of an employee, a workgroup, a building, a business unit and a geographical region.

20. The medium of claim 15, wherein in the method, the recommending an action comprises:
comparing the attendance trend to a disciplinary attendance policy; and
recommending a disciplinary action in accordance with the disciplinary attendance policy.

21. The medium of claim 15, wherein in the method, the affecting a trend comprises reducing absenteeism.

22. The medium of claim 15, wherein in the method, the recommending an action includes rewarding good attendance.

23. The medium of claim 15, wherein in the method, the evaluating the effectiveness of the action comprises:
recommending enforcement of a disciplinary attendance policy when the recommended action is not being performed; and
recommending review of the disciplinary attendance policy when the recommended action is being performed.

24. The medium of claim 23, wherein in the method, the review of the disciplinary attendance policy comprises, systematically eliminating non-contributing factors to determine a cause of the trend and recommending a change in the disciplinary attendance policy.

25. An apparatus for managing an attendance trend, comprising:
a processor which evaluates an attendance trend among a plurality of data objects having a relationship; and
a memory for storing data objects in the plurality of data objects, wherein the processor accesses the data objects and recommends an action affecting the attendance trend and evaluates the effectiveness of the recommended action in affecting the attendance trend.

26. The apparatus of claim 25, wherein the attendance trend comprises at least one of a pattern of absences, geographical distribution of absences and work group distribution of absences.

27. The apparatus of claim 26, wherein the pattern of absences comprises at least one of an absence proximate a holiday, absence proximate a weekend, absence proximate a recurring date and absence concurrent with a weather condition.

28. The method of claim 25, wherein the data objects comprise absence records and employee demographics.

29. The apparatus of claim 25, wherein the relationship comprises at least one of an employee, a workgroup, a building, a business unit and a geographical region.

30. The apparatus of claim 25, wherein the processor compares the attendance trend to a disciplinary attendance policy and recommends a disciplinary action in accordance with a disciplinary attendance policy.

31. The apparatus of claim 25, wherein the affecting the trend comprises reducing absenteeism.

32. The apparatus of claim 25, wherein the recommended action includes rewarding good attendance.

33. The apparatus of claim 25, wherein the processor recommends enforcement of a disciplinary attendance policy when the recommended action is not being performed and recommends review of the disciplinary attendance policy when the recommended action is being performed.

34. The apparatus of claim 33, wherein the review of the disciplinary attendance policy comprises, systematically eliminating non-contributing factors to determine a cause of the trend and recommending a change in the disciplinary attendance policy.
